(19) United States
(12) Patent Application Publication
(10) Pub. No.: US 2014/0136301 A1
(43) Pub. Date: May 15, 2014

(54) SYSTEM AND METHOD FOR VALIDATION AND RELIABLE EXPIRATION OF VALUABLE ELECTRONIC PROMOTIONS

(71) Applicant: Juan Valdes, Henderson, NV (US)

(72) Inventor: Juan Valdes, Henderson, NV (US)

(21) Appl. No.: 13/854,671

(22) Filed: Apr. 1, 2013

Related U.S. Application Data
(60) Provisional application No. 61/725,848, filed on Nov. 13, 2012.

(51) Int. Cl. G06Q 30/02

(52) U.S. Cl. CPC G06Q 30/0207
USPC 705/14.1

(57) ABSTRACT

A validation, redemption and reliable expiration system for valuable electronic promotional items provides an electronic promotion system without the need for merchant hardware. The electronic promotion system utilizes customer devices to scan one or more merchant tags to validate and redeem electronic promotional items. Once redeemed, the electronic promotional items are expired or invalidated locally on the customer device to prevent subsequent use. In this way, a full-featured promotion, loyalty card, and check-in system can be quickly and easily deployed at low or no hardware cost to the merchant, while preventing unauthorized use of valuable electronic promotional items.

### CROSS-REFERENCE TO RELATED APPLICATION

This application claims the benefit of U.S. Provisional Patent Application No. 61/725,848, titled System and Method for Location Verification and Promotion Redemption Without Use of Merchant Hardware, filed Nov. 13, 2012.

### BACKGROUND OF THE INVENTION

1. Field of the Invention

The invention relates to electronic promotion and redemption systems for merchants, and in particular to systems and methods for validation and reliable expiration of valuable electronic promotions.

2. Related Art

As merchants have sought to move from paper-based promotions to electronic promotions and loyalty cards, various technologies have been developed to serve the electronic promotion market. Many of these solutions utilize standard communications mediums such as email or social media to distribute electronic promotions to customers.

To accept electronic promotions, merchants install specific and sometimes proprietary hardware to validate and accept the promotions. Unfortunately, such hardware is costly and typically requires installation at point of sale locations. Alternatively, existing point of sale systems may be modified or upgraded to support validation and acceptance of electronic promotions. However, this too incurs merchant expense and is complex and time consuming. In many cases, the expense to install or upgrade appropriate systems is cost prohibitive thus preventing or hindering use of electronic promotions by the merchant. In addition, merchants are reticent to offer electronic promotions where redemption of such promotions cannot be easily controlled.

From the discussion that follows, it will become apparent that the present invention addresses the deficiencies associated with the prior art while providing numerous additional advantages and benefits not contemplated or possible with prior art constructions.

### SUMMARY OF THE INVENTION

An electronic promotion redemption, validation and reliable expiration system (hereinafter the “electronic promotion system”) that does not rely upon merchant hardware is disclosed herein. As detailed herein, the electronic promotion system is advantageous in that it allows merchants to provide electronic promotional items, such as electronic coupons, payment cards, loyalty cards and check-ins without requiring any merchant hardware. This eliminates costs in upgrading, maintaining or installing hardware to support electronic promotional items and check-ins. In addition, the electronic promotion system provides a guaranteed expiration feature whereby electronic promotional items are reliably expired to prevent unauthorized use. This allows merchants to issue valuable promotions without worry that they may be used beyond intended limits.

The electronic promotion system may have various configurations. In one exemplary embodiment for example, an electronic promotion system is disclosed, comprising one or more merchant tags located at a merchant's business location, a distribution server configured to store and distribute a plurality of electronic promotional items, and one or more portable customer devices.

The portable customer devices may comprise a scanning device configured to read the one or more merchant tags, a communication device configured to receive one or more of the plurality of electronic promotional items from the distribution server, and a storage device storing the one or more electronic promotional items received via the communication device.

A processor is included to determine the validity of the one or more electronic promotional items stored on the one or more storage devices, and if validated to subsequently expire the one or more electronic promotional items on the one or more customer devices without communication with the distribution server to prevent further use of the one or more electronic promotional items. The validity of the one or more electronic promotional items can then be determined using information read from the one or more merchant tags.

A display screen of the portable customer devices presents a validity indicator if the one or more electronic promotional items are validated by the processor. This informs the customer and/or merchant that an electronic promotion is valid allowing redemption of the electronic promotion to occur. It is noted that the plurality of electronic promotional items may be high value coupons offering at least a 20% discount but can also provide other electronic promotional items that provide benefits to customers, such as loyalty cards and payment cards.

The one or more electronic promotional items may be expired by deleting the one or more electronic promotional items from the storage device. Alternatively or in addition, the one or more electronic promotional items may be expired by deleting validation information associated with the one or more electronic promotional items or by storing an indicator of the same associated with the one or more electronic promotional items on the storage device. The validity of the one or more electronic promotional items may be determined using a public encryption key read from the one or more merchant tags, based on one or more validation rules, or both.

In another exemplary embodiment, a mobile device for an electronic promotion system is disclosed, comprising a communications device configured to retrieve one or more electronic promotional items from a remote distribution server, validation information associated with the one or more electronic promotional items, and a scanning device for reading one or more merchant tags.

A processor is provided to determine the validity of the one or more electronic promotional items based on the validation information and information read from the one or more merchant tags, and a display screen is included to present a validity notification if the one or more electronic promotional items is valid. A storage device stores the one or more electronic promotional items locally on the mobile device, and is configured to expire the one or more electronic promotional items to prevent subsequent use of the one or more electronic promotional items. The one or more electronic promotional items are expired locally on the mobile device without communication with the remote distribution server. For instance, the communication device may be configured to communicate with the distribution server only when retrieving the one or more electronic promotional items.

The expiration of the one or more electronic promotional items may be initiated by an input button presented on the display screen along with the validity notification. The one or more electronic promotional items may be expired by deleting or modifying at least a portion of the validation information, the one or more electronic promotional items, or both from the storage device.

It is noted that, the one or more electronic promotional items may be high value coupons offering discounts of at least 20%. In addition, the scanning device may be an optical device configured to read one or more types of barcodes, while the mobile device itself may be a portable device selected from the group consisting of a smartphone, tablet, PDA, and portable media player.

Various methods associated with electronic promotion validation, redemption, and reliable expiration are also disclosed herein. In one embodiment, a method for distributing and expiring a plurality of electronic promotional items is disclosed, comprising receiving the plurality of electronic promotional items at a distribution server from one or more merchants, receiving a selection of one or more of the plurality of electronic promotional items from a customer using a portable customer device, and storing the selection of the one or more electronic promotional items on the portable customer device. As stated above, the one or more electronic promotional items may be high value electronic coupons offering at least a 20% discount but can be of lower value.

This method also includes generating one or more merchant tags for distribution and display at one or more business locations of the one or more merchants, reading the one or more merchant tags with a scanning device of the portable customer device, and determining the validity of the one or more electronic promotional items using the portable customer device and information read from the one or more merchant tags.

A validity notification is then presented to the one or more merchants via a display screen of the customer device to allow redemption of the one or more electronic promotional items if the one or more electronic promotional items are determined to be valid. The one or more electronic promotional items are then expired locally at the portable customer device without communication with the distribution server to prevent subsequent use of the one or more electronic promotional items. The distribution server may subsequently be updated regarding the redemption of the electronic promotional item. This allows the distribution server to collect redemption information about the electronic promotional items it provides, such as in a database.

The portable customer device will typically be a mobile device belonging to the customer. The one or more electronic promotional items may be expired by deleting or modifying validation information necessary to validate the one or more electronic promotional items from the portable customer device. An input button configured to initiate the expiration of the one or more electronic promotional items when engaged may be presented on the display screen of the customer device. It is noted that the information read from the one or more merchant tags may comprise a public encryption key for use during validation of an electronic promotion.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary electronic promotion system and environment of use;

FIG. 2 is a block diagram illustrating an exemplary customer device;

FIG. 3 is a flow diagram illustrating operation of an exemplary distribution server and customer device;

FIG. 4 is a flow diagram illustrating operation of an exemplary distribution server;

FIG. 5 is a flow diagram illustrating operation of an exemplary customer device;

FIG. 6A illustrations an exemplary notification screen showing a valid notification; and

FIG. 6B illustrates an exemplary notification screen showing an invalid notification.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the electronic promotion system herein allows a merchant to provide and accept electronic promotional items that can be verified and invalidated or expired without merchant provided external hardware. In this manner, expiration of electronic promotional items can be guaranteed to prevent multiple or unauthorized redemptions. This is beneficial especially with regard to electronic promotional items, which can be more easily duplicated than traditional paper or printed promotions.

As used herein, an electronic promotional item may be an electronic coupon providing various discounts, products, rewards or other benefits to a customer that redeems the coupon. The guaranteed expiration of electronic promotional items allows high value electronic promotional items to be provided by and, importantly, controlled by merchants. For instance, an electronic promotional item providing substantial discounts of 20% or more, or providing monetary value for making purchases could be provided without concern for overuse or unauthorized use. It is noted that the electronic promotion system may also provide electronic promotional items in the form of electronic payment cards, loyalty cards and check-ins as will be described further below.

In addition, the electronic promotion system herein is fully operational without requiring the merchant to install any hardware or software. This allows the electronic promotion system to be deployed by a large user base of merchants, including merchants that may not be “computer savvy.” As will be detailed further herein, the electronic promotion system utilizes customer devices for all scanning/redemption, validation, and expiration services. This allows electronic promotional items and check-in systems to be implemented without any hardware cost to the merchant. In addition, this characteristic results in greatly increased reliability and availability since the redemption, validation and expiration of electronic promotional items occurs without reliance upon merchant provided external devices or hardware. A large and increasing number of customers already own or will own hardware capable of functioning as the customer device as disclosed herein.

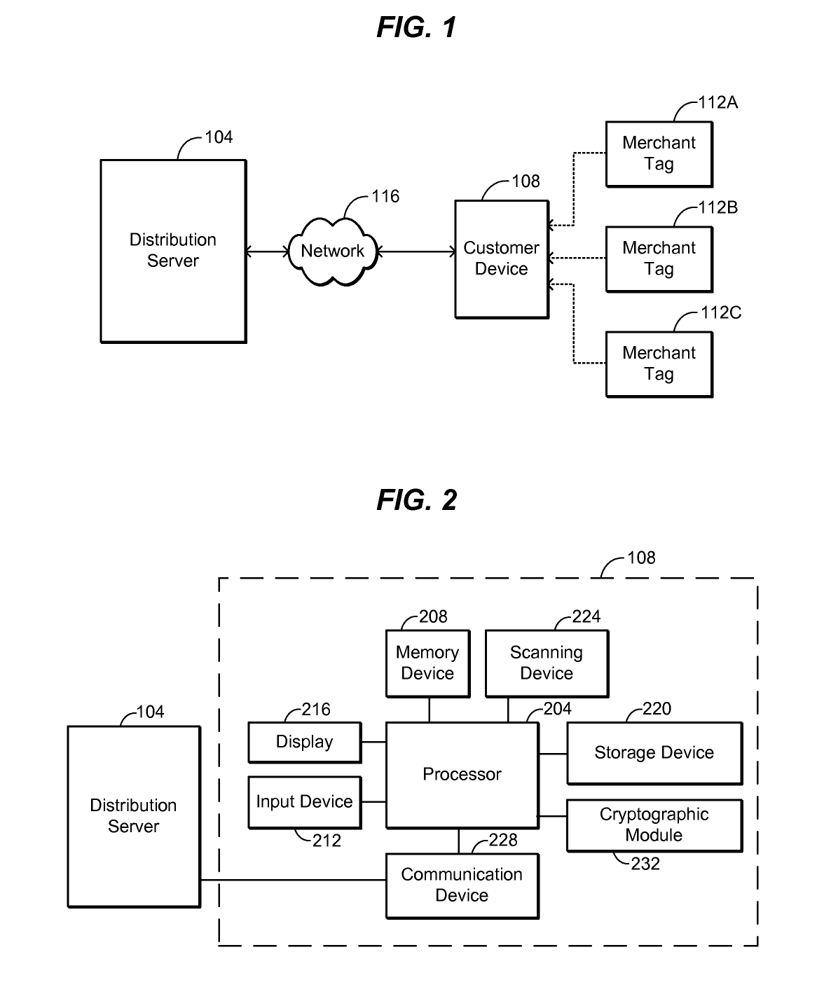

The electronic promotion system will now be described with regard to FIG. 1. FIG. 1 is a block diagram illustrating an exemplary distribution server 104 in an environment of use. As can be seen, the distribution server 104 may be a network-connected device, such as a server or appliance configured to provide the functionality herein. In a server or similar configuration, the electronic promotion system may comprise one or more processors configured to execute machine-readable code or other instructions to provide the functionality disclosed herein. The distribution server 104 may include or have access to various data storage devices for retrievable storage of information related to electronic promotional items such as coupons, loyalty cards, payment cards, check-ins and the like. In one or more embodiments, the instructions executed by the one or more processors may be stored on such a data storage device. Alternatively, some or all of the instructions may be hardwired into the one or more processors.

The distribution server 104 may include one or more communications devices as well for communicating with external devices. A communication device will typically be configured to establish one or more communications links with such devices. It is contemplated that a communication device may utilize various standard or proprietary communications protocols and communicate via one or more wired or wireless communications links. Where needed, such protocols may include encryption or other security measures as well as data compression or other bandwidth preservation measures.

The distribution server 104 may communicate directly with an external device via one or more of its communication devices. Alternatively or in addition, communication with external devices may occur over various networks 116, including but not limited to a LAN, WAN, or the Internet. This capability allows communication to occur across a variety of distances and between various locations. In this manner, the distribution server 104 can be located remote from the merchants it serves and can be accessed from virtually anywhere.

During operation, a distribution server 104 will typically receive various electronic promotional items created by merchants. The electronic promotional items may include an offer or benefit provided by the electronic promotional items, such as a discount, monetary value or reward. One or more criteria for expiring an electronic promotional item may also be provided. For example, the merchant may provide an expiration date, number of authorized uses, and/or other terms and conditions that would expire or otherwise invalidate the electronic promotional item thereby preventing further use of the electronic promotional item. The distribution server 104 may store the electronic promotional items, such as described above, for distribution to one or more consumers. A user interface, such as a website or the like, may be provided to receive electronic promotional items created by merchants. It is contemplated that the user interface may also be used to create electronic promotional items in one or more embodiments.

Referring now to FIG. 1, it can be seen that the electronic promotion system may comprise a distribution server 104 and one or more customer devices 108. As shown in FIG. 1, the distribution server 104 is shown communicating with a customer device 108. In general, a customer device 108 will be a hardware device configured to retrieve electronic promotional items from the distribution server 104 and to scan or otherwise read one or more merchant tags 112, and update the distribution server with redemption information comprising of time of use, location information (such as GPS coordinates), tag scanned and various other relevant data to log the redemption of the electronic promotional item, as will be described in further detail below. Some exemplary customer devices 108 include handheld or portable computing devices with one or more sensors, such as smart phones, tablet computers, PDAs, laptops, portable media players, and the like. Some exemplary sensors include, cameras, microphones, radio frequency readers or near field communication devices, barcode scanners, and the like.

It is noted that the distribution server 104 may communicate with other devices as well. For example, the distribution server 104 may be in communication with one or more financial institutions such as to effectuate fund transfers when a merchant purchases electronic promotional items (i.e., electronic coupons, loyalty cards, payment cards) for its customers. In addition, a merchant may access the distribution server 104 via the distribution server's communication device to setup, modify, or delete coupons, loyalty cards, payment cards or other electronic promotional items available on the electronic promotion system. For instance, it is contemplated that the distribution server 104 may provide a web interface, software application, or the like to allow a merchant to remotely interact with and use the distribution server, as will be detailed further below.

No communication is required between a merchant and the distribution server 104 to distribute, validate, or accept electronic coupons, check-ins, or the like. Again, this is because the distribution server 104 does not rely upon hardware possessed by the merchant during the distribution, validation, or acceptance process. Therefore, the merchant is freed from providing his or her own hardware.

In a typical embodiment and as will be described in further detail below, communication between the distribution server 104 and customer device 108 is also limited. For example, communication between the distribution server 104 and a customer device 108 may be limited to transmission of electronic promotional items from the distribution server to the customer device (i.e., communication is limited to promotion distribution). In this manner, reliance upon the distribution server 104 (or other external device) for redemption, validation, and reliable expiration of electronic promotional items is eliminated thus increasing the reliability and availability of the overall system. As long as a customer device 108 has received an electronic promotional item from the distribution server 104, and is functioning, the electronic promotional item can be redeemed, verified, and expired to prevent further use. This is highly advantageous in that it allows an electronic system to match the reliability of traditional paper or print based promotions.

In some embodiments, this limited communication may be more expansive. For example, redemption information for one or more electronic promotional items may be transmitted from the customer device to the distribution server (though as stated such transmission from the customer device is not required to validate an electronic promotional item). It is noted that he transmission of redemption information from the customer device need not be immediate because the customer device may store the redemption information for one or more electronic promotional items locally on its storage device for later transmission to a distribution server to update the distribution server.

In addition or alternatively, a customer device 108 may communicate with a distribution server 104 when electronic promotional item is redeemed or verified. Typically however, the customer device 108 will be configured to expire or otherwise invalidate electronic promotional item without relying upon the distribution server 104 or any other device. This is beneficial in that it ensures electronic promotional item will not be used beyond their intended usage limits.

To redeem an electronic promotional item or to check-in, the customer device 108 would be used to read or scan one or more merchant tags 112 located at the merchant's business location. Each merchant tag 112 will typically carry a unique identifier so as to distinguish it from other merchant tags. After being scanned by a customer device 108 the unique identifier on a merchant tag 112 may be transmitted from the customer device 108 to the distribution server 104. If verified, the distribution server 104 may return notification of the same to the customer device 108 that may be presented to the merchant for review.

Alternatively or in addition, a merchant tag 112 may include information used to validate an electronic promotional item at the customer device 108, without need for communication with the distribution server. For instance, a merchant tag 112 may comprise a public key to validate an electronic signature associated with an electronic promotional item. As another example, a merchant tag 112 may include other information, such as a text or character string, used to evaluate the validity of the electronic promotional item by matching such string to a corresponding string associated with the electronic promotional item.

Some exemplary merchant tags 112 include barcodes, QR codes, RFID tags and the like. Typically, the merchant tags 112 will not rely upon additional electronics, devices, or technology per se. In other words, the merchant tags 112 will typically be a non-electronic or non-technological solution that does not need to be attached or connected to a power source or external support device to operate. This eliminates requirements for hardware to be provided by a merchant, as well as associated maintenance. In addition, merchant tags 112 are thus low cost and easily and quickly replaceable. For example, in one or more embodiments, a merchant tag 112 may as simple as a label, printout, sticker or the like bearing a unique identifier in a form readable by a customer device 108, and may be removable/replaceable if damaged.

If the merchant accepts the notification presented on the customer device 108 as valid, the merchant may then provide the corresponding benefit (e.g., discount, complementary product or service) to the customer. As can be seen, this acceptance process without use of any merchant hardware. Typically, a quick visual inspection of the validation notification on the customer device 108 is sufficient for the merchant to accept an electronic promotional item. In this manner, a customer need not hand possession of his or her customer device 108 to a merchant, even for a moment. It is noted that some actions need not be reviewed by the merchant. For example, a merchant tag 112 may be provided for the purposes of allowing customers to check-in to the merchant's location. A check-in of this sort may be accepted when the customer scans such merchant tag 112 and without further review by the merchant.

As shown in FIG. 1, one or more merchant tags 112 may be provided by a single merchant. For example, a first merchant tag 112A may be provided at a point of sale location, such as for electronic coupon, loyalty card or payment card redemptions, while a second and/or third merchant tag 112B, 112C are provided for check-ins. It is noted that each merchant tag 112 may be associated with the merchant location (e.g., business location) as well as with more specific location information. For example, each merchant tag 112 may be associated with a particular area or location within the merchant's physical location. Scanning of these merchant tags 112 would also indicate the location within the merchant's store (or other location) where a customer was present.

In one or more embodiments, the distribution server 104 may have a database or other listing recording individual merchant tags 112 associated with their type or purpose, their location and/or owner, among other associated information. This tag information can then be retrieved when the distribution server 104 receives a merchant tag's unique identifier from a customer device 108. The distribution server 104 may then proceed according to the purpose or other information associated with the merchant tag 112 as will be described further below.

Though shown in FIG. 1 with a single customer device 108 and a set of merchant tags 112 it will be understood that the distribution server 104 may be used by multiple customer devices 108 simultaneously. In addition, the distribution server 104 is capable of issuing and processing one or more merchant tags for a plurality of merchants.

FIG. 2 is a block diagram illustrating an exemplary customer device 108. As can be seen, a customer device 108 may comprise one or more processors 204, storage devices 220, and communication devices 228. The one or more processors 204 may be configured to execute machine-readable code or other instructions to provide the functionality disclosed herein. In one or more embodiments, the instructions may be hardwired into a processor 204 or may be stored on a storage device 220 for retrieval and subsequent execution by the processor. It is contemplated that the instructions may be downloaded from the distribution server or from another external data source for storage and execution on the customer device in one or more embodiments. One or more memory devices 208 may be used as a cache or other temporary data storage during execution of the instructions.

A storage device 220 may also be used to store electronic promotional items locally on a customer device 108. This is advantageous in embodiments where communication between a customer device 108 and a distribution server 104 are limited because local storage allows electronic promotional items to be redeemed as long as the customer device is operational (regardless of the operational state of the distribution server). Typically, the storage device 220 will also be configured to expire or otherwise invalidate a particular electronic promotional item after it has been redeemed, such as by deleting or modifying the electronic coupon, loyalty card or payment card itself, or by deleting or modifying information necessary to validate the electronic promotional item thereby rendering the electronic promotional item unusable.

A communication device 228 will typically be configured for wireless communication with external devices. For example, a communication device 228 may communicate via a cellular radio, Wi-Fi, Bluetooth or the like. A communication device 228 may utilize various standard or proprietary communication protocols and may utilize encryption, compression or other data security and efficiency methods. In any case, the communication device 228 will be configured at least to be capable of communication with the distribution server 104. A wired communication device 228 may be utilized in some embodiments, however since the customer device 108 will typically be a portable or mobile device, the communication device 228 will typically be wireless as well. Some exemplary communications between the customer device 108 and distribution server 104 include merchant tag unique identifiers as well as notifications and validations of the same.

The customer device 108 will typically also include one or more input devices and one or more output devices to allow a customer to interact and use the customer device. For example, an output device in the form of a screen 216 may be provided to provide information and feedback to a customer, while and input 212 such as a touch screen, one or more buttons, or the like are used to receive input or commands from the customer. In operation, the input and output devices may be used by a customer to select one or more electronic promotional items, such as coupons/promotions, payment cards, loyalty cards and the like offered through the electronic promotion system via his or her customer device 108.

As can be seen, the customer device 108 also includes a reader or scanning device 224 used to scan merchant tags. As described briefly above, the scanning device 224 may comprise various optical, audio, radio frequency or other scanners to read merchant tags. In one embodiment for example, the scanning device 224 may comprise a camera or optical scanner for reading merchant tags comprising a barcode, QR code, or the like.

In addition, the customer device 108 may optionally include one or more cryptographic modules 232. It is noted that a cryptographic module 232 may be provided in a hardware or software implementation in the various embodiments of a customer device 108. If provided, the cryptographic module 232 will typically be configured to validate or authenticate electronic signatures of merchant tags. Alternatively or in addition, a cryptographic module 232 may be used to generate electronic signatures that may be presented to a merchant for validation.

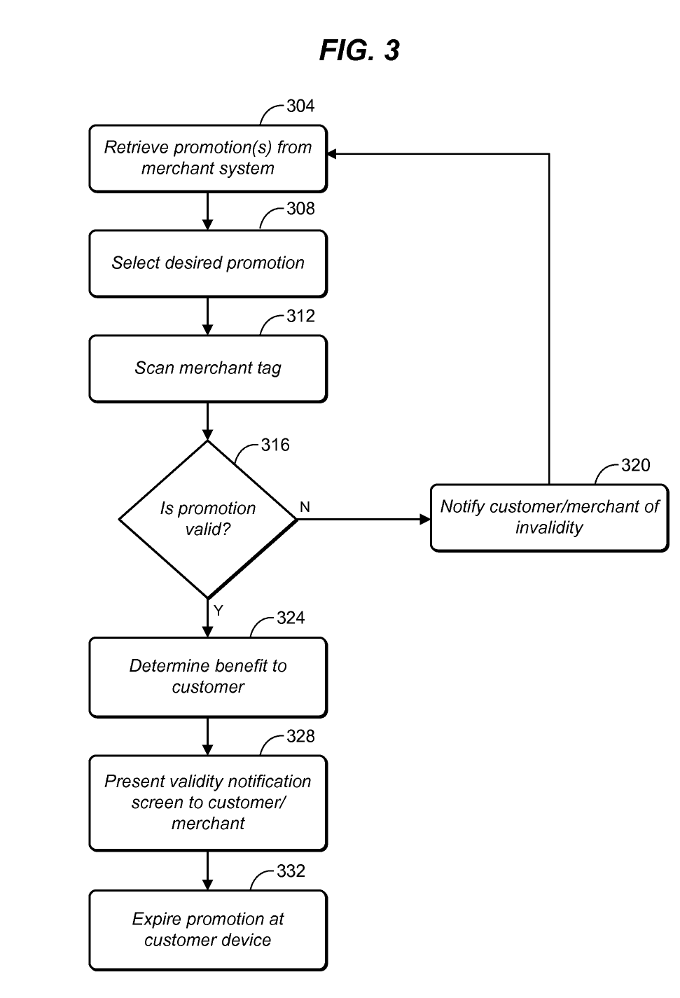

Operation of the distribution server and customer device(s) will now be described with reference to the flow diagram of FIG. 3. As will become apparent from the following, FIG. 3 illustrates an exemplary process by which an electronic promotional item can be selected, redeemed and expired via the electronic promotion system. Though described with respect to electronic coupons, it is noted that other electronic promotional items such as loyalty card stamps/redemptions, payment card payments and check-ins may be completed according to the following as well. In addition, it is contemplated that payment transactions may be completed as well.

At a step 304, a customer may retrieve one or more electronic coupons he or she is interested in redeeming. In one or more embodiments, the customer may browse a listing of available electronic coupons on his or her customer device and add the ones he or she desires. Alternatively, a customer may retrieve a particular electronic coupon that was shared with the customer via email or other means. Typically, the retrieved electronic coupons will be stored on a storage device of the customer device. In this manner, the retrieved electronic coupons are locally accessible at the customer device without the need for any other external hardware. The retrieved electronic coupon(s) can then subsequently be selected for redemption via the customer's device.

In one or more embodiments, the desired electronic coupons may be added to a customer account that the customer may establish on the distribution server. The customer may provide identifying information such as a name, username, email, and/or password to setup an account. The account may also collect demographic and other information the customer wished to provide. For example, the customer may provide his or her age, gender, education level, address as part of the account creation process. Subsequently, the customer can retrieve the electronic coupons associated with his or her account by logging into the account.

To redeem a particular one of the electronic coupons available via the customer device, the customer may select the particular electronic coupon at a step 308, such as by engaging an input device of the customer device. This identifies the electronic coupon to be redeemed thus distinguishing it from other electronic promotional items that are available on the customer device. Once an electronic coupon is selected, the customer device may activate a scanning device to allow the customer to scan a merchant tag. The customer device may then transmit the merchant tag's unique identifier to the distribution server for validation at a decision step 316.

It is noted that various other information may be transmitted as well. Typically, an identifier for the electronic coupon (uniquely identifying the electronic coupon being redeemed) and/or a customer identifier (uniquely identifying the customer or the customer device) may be sent to the distribution server. The distribution server may then utilize this information to validate the redemption according to one or more predefined validation rules. For example, the distribution server may validate an electronic coupon by determining whether or not the selected electronic coupon is offered by the same merchant as that of the scanned merchant tag. In addition or alternatively, the distribution server may use a customer identifier to validate that an electronic coupon has not been redeemed more than a merchant defined maximum number of times, that an electronic coupon has not expired, or both.

Also, various other information stored on the customer device may be transmitted to the distribution server during the redemption process. For example, location information detected by a location sensor (such as a GPS device or triangulation device) may be transmitted. In addition, information stored on the customer device, such as address information, contact information, or the like may be transmitted. If authorized, information regarding any other applications and the data therefor may be transmitted to the distribution server as well.

The distribution server may also validate other aspects of an electronic coupon. For example, the distribution server may validate that an electronic coupon is not expired or otherwise invalid. Other prerequisites may also be verified. For example, certain electronic coupons may only be valid at certain times or certain days. In addition, the distribution server may validate the customer's physical location. This is because each merchant tag may be associated with a geographic location of the merchant's business and/or a location within the merchant's business, such as described above. Some electronic coupons may thus be configured to be valid only at particular business locations or locations within business locations.

If the electronic coupon is not valid or not verified at decision step 316, a notification of the same may be transmitted back to the customer device from the distribution server at a step 320. Typically, this will result in an invalid or unverified notified being displayed or otherwise presented by the customer device. A merchant can then readily determine that the electronic coupon should not be accepted by reviewing an output device (e.g., screen) of the customer device when the customer presents it to the merchant as part of the redemption process.

If the electronic coupon is valid/verified at decision step 316, the distribution server may proceed accordingly to a step 324. As shown, the distribution server may identify the benefit to provide to the customer. For example, the amount of a discount or other reward to be provided to the customer may be retrieved from the distribution server's database at step 324. Typically, this benefit information will be associated with the electronic coupon via the electronic coupon identifier or the like. It is noted that step 324 is optional since the merchant may have its own records of what benefits to provide, or it may be apparent from the electronic coupon being redeemed.

At a step 328, a notification that the electronic coupon is valid may be presented via the customer device, such as on the screen of the customer device. In embodiments where the electronic coupon system identifies the benefit to provide to the customer, this notification may also include the benefit to be provided. The merchant can then readily determine the electronic coupon is valid by reviewing the customer device's output. The corresponding benefit (e.g., discount) can then be provided to the customer by the merchant.

At a step 332, the redeemed electronic coupon may be expired or invalidated. Typically, this will occur at the customer device without communication between the customer device and the distribution server. In this manner, further use of the electronic coupon is prevented without reliance upon the distribution server or other external device. Electronic coupon expiration may occur in various ways. In one or more embodiments, the electronic coupon may be deleted from the customer device. In addition or alternatively, the electronic coupon may be marked as used so as to be no longer redeemable.

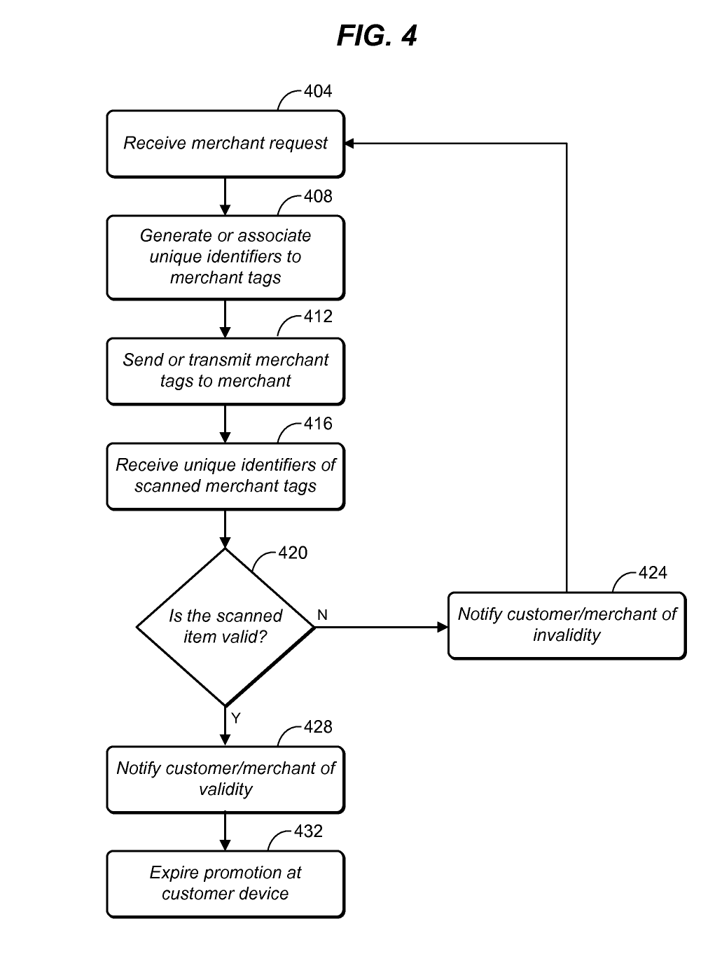

Additional details regarding operation of the electronic promotion system will now be described with regard to FIG. 4. FIG. 4 is a flow diagram illustrating operation of an exemplary distribution server in provisioning merchant tags and processing redemptions thereof. At a step 404 a request for one or more merchant tags may be received from a merchant. Typically this will occur when a merchant requests coupons, check-in capability, or loyalty cards for his or her business. It is noted that the distribution server may require and collect payment from the merchant in exchange for providing these items. The merchant may specify the number of merchant tags he or she desires for placement/use at his or her business location.

It is contemplated that a merchant may be required to establish a merchant account at the distribution server before making a request. For instance, the merchant may be prompted to provide identifying information, billing information, contact information or the like to establish a merchant account. The distribution server may then associate the merchant's electronic promotional items and any check-ins with this merchant account. In addition, the distribution server may validate and effectuate payment for the same using the billing and other information.

Once a request is made, the merchant tags may have their unique identifier stored in a data storage device of the distribution server at a step 408. In one embodiment, this may occur by scanning the unique identifiers of already existing merchant tags into the distribution server. In another embodiment, the distribution server may generate an output used to create a merchant tag. For instance, the distribution server may generate an image file or the like having a unique identifier that can be used to print or otherwise create a merchant tag.

As described above, the unique identifier of a merchant tag may be associated with an electronic promotional item, such as individual electronic coupons, loyalty cards or payment cards. In this manner, the distribution server can later validate whether scanning of a particular merchant tag should entitle a customer to the benefit associated with the electronic promotional item. It is contemplated that various combinations of electronic promotional items and check-ins can been associated with a single merchant tag and still be verifiable by the distribution server. This is because the customer device may be configured to transmit the electronic promotional item or check-in the customer is attempting to activate (e.g., redeem) along with the merchant tag's unique identifier. The distribution server can then validate this association during the redemption process.

At a step 412, the merchant tags may be sent to the merchant. In some embodiments, the merchant tags may be mailed or otherwise physically delivered to the merchant. In other embodiments, the merchant tags may be electronically delivered so that a merchant may print them out. Once received by the merchant, the merchant tags can be placed at various locations at the merchant's business location. Alternatively or in addition, merchant tags may be securely stored at the business location for authorized use as disclosed above.

At a step 416, the distribution server may receive scanned unique identifiers from a customer device scan of a merchant tag. At a decision step, the distribution system may validate the unique identifier such as described above with regard to the flow diagram of FIG. 3. If verified, a notification of the same may be transmitted to the customer device at a step 428. Subsequently, at a step 432, the electronic promotional item may be expired or validated at the customer device to prevent further use. As described above, this will typically occur without communication with the distribution server or any other external device. If not verified, a non-validation identifier may be transmitted back to the customer device at a step 424. It is noted that the electronic promotional item may be expired after step 424 as well.

It is contemplated that the same or a similar electronic promotional item may be retrieved or downloaded from a distribution server further use after an electronic promotional item expires. If necessary, a merchant may modify the expiration or maximum number of redemptions for an electronic promotional item so that it remains redeemable.

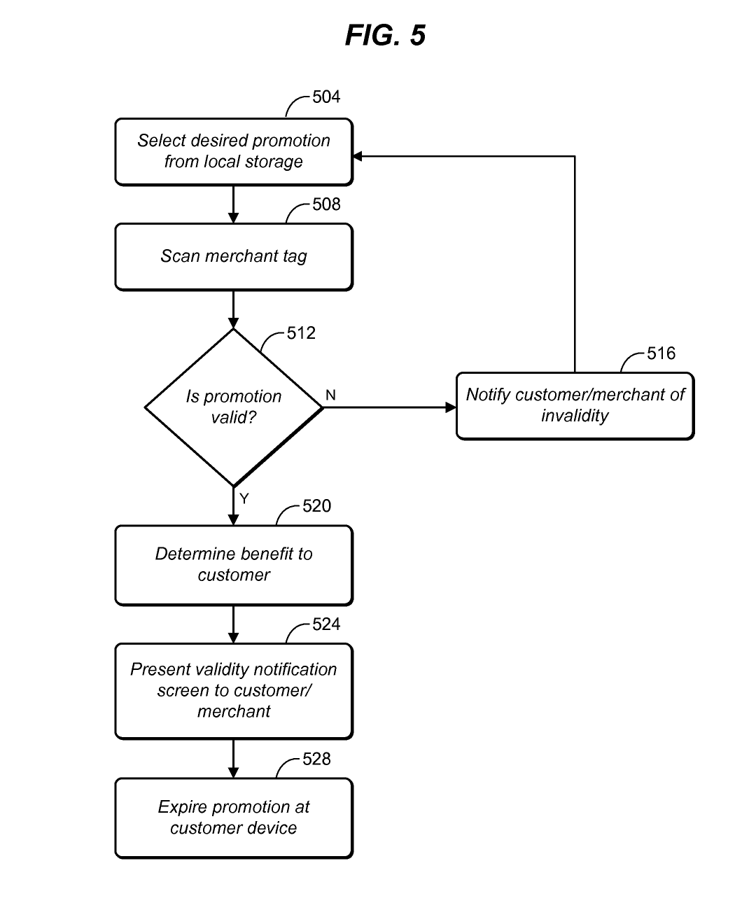

As disclosed above, communication between a distribution server and a customer device may be limited to various extents. FIG. 5 is a flow diagram illustrating operation of an exemplary customer device where communication with a distribution server or other device is not required and does not occur after one or more electronic promotional items are retrieved and stored on the customer device. As will become apparent from the following, this increases the reliability and availability of the electronic promotion system in that the electronic promotion system will be fully operational as long as the customer device is operational. This is so regardless of whether or not the distribution server or other external device is operational.

At a step 504, a customer may select his or her desired electronic promotional item from the local storage device of the customer device, such as by engaging an input device of the customer device. It is noted that a selection of electronic promotional items may be downloaded from a distribution server for storage on the local storage device prior to step 504. In general, each electronic promotional item on the local storage device will include information to validate the material at the customer device without need for communication with a distribution server or any other device.

At a step 508, the customer device may be used to scan a merchant tag to begin the redemption process. At a decision step 512, the customer device may validate the validity of the selected electronic promotional item. This may occur in various ways as will now be described.

As stated above with regard to FIG. 3, validation may include validating that various criteria associated with the electronic promotional item have been met according to one or more validation rules. For instance, a customer device may validate that the electronic promotional item is not expired, is being used at a valid location and/or time, has not been used more than a predefined number of times, and the like when validating the electronic promotional item. The expiration date, valid location/time, predefined maximum number of redemptions and other information may be part of the electronic promotional item stored on the customer device's storage device.

Validation may require information from a particular merchant tag. For example, the location at which an electronic promotional item is being redeemed may be verified (directly or indirectly) with information read from a merchant tag. To illustrate, the merchant tag may include information specifying its location. Alternatively, scanning of a particular merchant tag will inform the customer device that the customer is at a location where the electronic promotional item can be properly redeemed.

An electronic promotional item will typically include information that may be matched or compared with information from a merchant tag for validation purposes. For example, an electronic promotional item may include an identifier of one or more particular merchant tags that, if scanned, would render the electronic promotional item valid and thus redeemable. Alternatively, in another example, an electronic promotional item may include one or more valid locations (such as by name, geographic coordinates, or other identifier). If matching location information is read from a merchant tag, the electronic promotional item may be deemed valid and thus redeemable. If not, the customer would not be permitted to redeem the electronic promotional item, such as will be described with regard to a step 516 below.

In addition, the authenticity of an electronic promotional item may be validated. This ensures that the electronic promotional item was issued and authorized by a merchant, and is beneficial in that it gives merchants the confidence to issue high value electronic promotional items. Such authenticity validation may occur in various ways.

In one or more embodiments, the storage device of the customer device may store validation information to validate one or more electronic promotional items. For example, such validation information may comprise one or more electronic signatures, hash values, or other information that may be used to validate electronic promotional items. The validation information can then be used for comparison to determine if an electronic promotional item is valid or not. Alternatively or in addition, a merchant tag may include such signatures, hash values or other validation information. If improper or incorrect validation information is retrieved from the storage device or a merchant tag, the electronic promotional item cannot be validated, and thus cannot be redeemed.

It is noted that the customer device may utilize its cryptographic module during the validation process. For instance, a hash value, such as an MD5 or SHA hash, may be generated for the electronic promotional item combined with information from the scanned merchant tag. If the resulting hash value matches that stored in the validation information (for the particular electronic promotion), the electronic promotional item may be deemed valid. If not, the electronic promotional item will be deemed invalid, and the customer and merchant may be notified of the same at a step 516. In general, such notification will alert or notify the customer and/or merchant that a particular electronic promotional item is invalid. One or more visual displays, audible alerts, or both may be presented by an output of the customer device to as a notification of the electronic promotional item's invalidity.

It is noted that an electronic signature could be used in lieu of a hash value in some embodiments. In such embodiments, a public key infrastructure could be used to validate electronic promotional items. For instance, a merchant tag may supply the merchant's public encryption key (i.e., public key). The customer device, such as via its cryptographic module, may then use the public key to decrypt an encrypted signature of the electronic promotional item stored locally on the customer device. If the decrypted signature contains a valid hash value for the electronic promotional item, the electronic promotional item may then be deemed valid.

In other embodiments, the validation information may not utilize encryption or hashing. For instance, the validation information may contain text/character strings, binary data, or other information that must match corresponding strings/data read from a merchant tag for an electronic promotional item to be deemed valid. In this manner, if information read from a merchant tag matches the validation information stored on the customer device, the electronic promotional item may then be deemed valid.

If the electronic promotional item is valid, the benefit to the customer can then be determined at a step 520. This determines the amount of a discount or other reward to be provided to the customer. Typically, this information will be downloaded from a distribution server along with the one or more electronic promotional items the customer selects from the distribution server. In this manner, the customer device can determine the benefit to be provided by retrieving the same from its storage device. This benefit information may be presented to the customer and/or merchant via a display of the customer device. As described above with regard to FIG. 3, this step 520 may be optional as the merchant may already be aware of the benefit to be provided, or the benefit may be apparent to the merchant from the particular electronic promotional item being redeemed.

At a step 524, a notification may be presented on the display or other output device of the customer device indicating that the electronic promotional item is valid. Once the notification is acknowledged by the merchant (such as by the merchant viewing the display of the customer device), the electronic promotional item may be expired at a step 528 to prevent further use. As stated above, the electronic promotional item may be deleted from the local storage device of the customer device to expire the electronic promotional item, or modified such that it can no longer be redeemed.

Alternatively or in addition, validation information necessary to validate the electronic promotional item may be deleted, modified or destroyed to prevent further use of the electronic promotional item. It is contemplated that a merchant defined number of redemptions may be permitted before expiration of the electronic promotional item occurs at step 528. Because expiration occurs immediately by the customer device, the electronic promotional item is reliably expired thus preventing further use without the need for communication with or use of a distribution server or any other device.

In some embodiments, the customer device may store redemption information recording the redemption or use of one or more electronic promotional items. For instance, redemption information may include the time of redemption, the number of redemptions, the location of the redemption, among other things. It is contemplated that the redemption information may but need not be periodically transmitted to a distribution server to update a database or other record of redemptions for one or more electronic promotional items stored thereon. Since the redemption information may be stored locally on a customer device, such transmission need not occur immediately after a redemption occurs.

As stated above, an electronic promotional item may be a loyalty card, payment, or payment card. For loyalty cards, the customer may select the desired loyalty card from one or more loyalty cards available via his or her customer device, such as via an input device of the customer device. The loyalty card may be “stamped” by scanning a merchant tag at the merchant's location associated with the loyalty card. As discussed above, the electronic promotion system may validate the loyalty card using information from the customer device's storage device, a merchant tag, or both before providing a stamp or otherwise allowing the loyalty card to be redeemed.

To effectuate a payment, it is contemplated that a customer may select a “credit” gift or other payment card via an input device of the customer device. The payment card will typically include information specifying one or more merchant tags that must be scanned before the gift card can be redeemed (i.e., charged). This is used to validate the payment card. In this manner, the customer may charge the payment card by scanning the appropriate merchant tag typically provided by the merchant that created the payment card. If an incorrect or unspecified merchant tag is scanned, the payment card cannot be validated and thus cannot be redeemed.

In one or more embodiments, loyalty cards and payment cards may be selected and downloaded from a distribution server for storage locally on a customer device's storage device, such as described above. In addition, loyalty and payment cards may include information needed to validate their redemption, such as expiration dates, valid locations, and the like. Loyalty cards will typically specify a free or reduced cost product or service as a benefit, while a payment card may specify a credit limit or other monetary value that may be redeemed such as to purchase goods or services.

The customer may be required to buy or prepay for payment cards from a merchant. If validated, the amount of the customer's purchase may be deducted from the payment card by lowering the value associated with the payment card stored on a local storage device. This ensures that the customer is limited to the amount he or she has paid for when using a payment card.

For check-ins, which indicate a customer's presence at a particular business location or at a particular location within the business location, it is contemplated that the validation portion of the process need not be used. In this manner, the customer may be deemed checked-in upon scanning of a merchant tag at the location where the customer wishes to check in. Typically, check-ins will activate communication with a distribution server or other device, such as a server of a social media service, to record the check-in.

It is contemplated that the merchant may control access to a merchant tag if necessary. For example, the merchant need not make a merchant tag readily available to customers. This is advantageous in that it allows merchants to control access to their electronic promotional items and check-ins because they have physical control over the merchant tags. Thus, a merchant may secure or hide a merchant tag until a customer properly requires access to scan the merchant tag. This can be used to prevent improper or deceptive check-ins or loyalty card stamps for example.

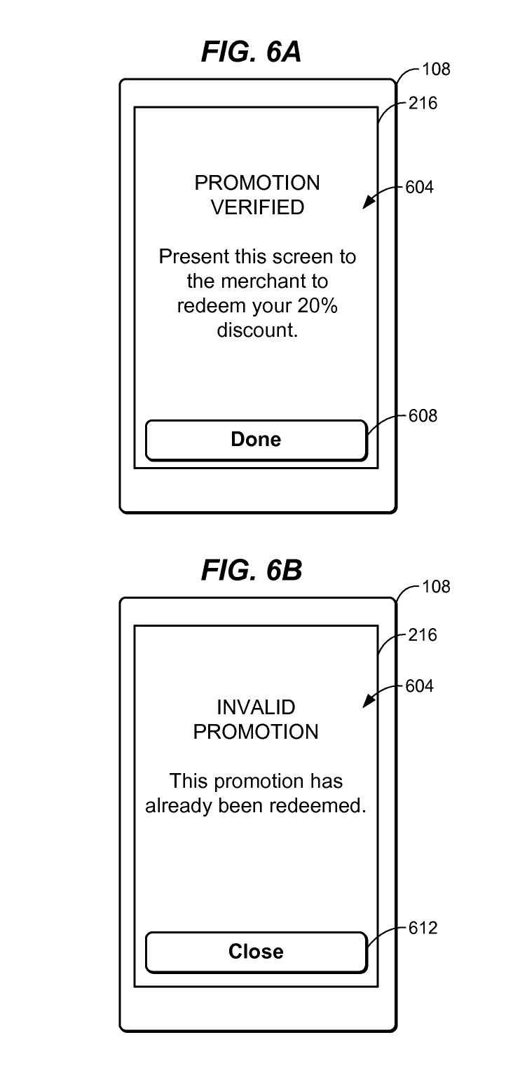

FIGS. 6A and 6B illustrate exemplary notifications of the validity or invalidity of an electronic promotional item, respectively. In addition, a benefit identifier 604 may be presented to display the benefit being provided. Referring to FIG. 6A, it can be seen that a validity notification allows a merchant and/or customer to readily ascertain that an electronic promotional item is valid and can be redeemed. Namely, in this exemplary notification information is presented indicating that an electronic coupon has been verified. It is contemplated that a merchant may acknowledge this by engaging a “Done” button 608 or the like on the validity notification. Such acknowledgment may initiate expiration of the electronic coupon locally at the customer device. If multiple redemptions of the electronic promotional item are permitted (as defined by its associated merchant), the “Done” button 608 will typically not expire the electronic coupon until after the defined maximum number of redemptions has been reached.

In contrast to FIG. 6A, the invalidity notification of FIG. 6B indicates that the electronic coupon is expired or invalid and should not be redeemed. In this case, the benefit identifier 604 indicates there is no benefit to be provided. The customer may engage a “Close” button 612 or the like to close or dismiss this notification. Thereafter, the customer may delete the invalid electronic coupon, or select another electronic promotional item to redeem if desired and if available.

Though described above with regard to an electronic coupon, it is noted that a similar validity or invalidity notification may be provided for loyalty card, payment card, check-in and other services provided by the electronic promotion system. In the case of a loyalty card, the benefit identifier 604 may include the current number and required number of stamps along with a corresponding reward for obtaining the required number stamps. In the case of a payment card, the benefit identifier 604 may show the amount remaining on the payment card.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An electronic promotion system comprising:
one or more merchant tags located at a merchant's business location;
a distribution server configured to store and distribute a plurality of electronic promotional items;
one or more portable customer devices comprising:
a scanning device configured to read the one or more merchant tags;
a communication device configured to receive one or more of the plurality of electronic promotional items from the distribution server;
a storage device storing the one or more electronic promotional items received via the communication device;
a processor configured to determine the validity of the one or more electronic promotional items stored on the one or more storage devices, and if validated to subsequently expire the one or more electronic promotional items on the one or more customer devices without communication with the distribution server to prevent further use of the one or more electronic promotional items; and
a display screen configured to present a validity indicator if the one or more electronic promotional items are validated by the processor;
wherein the validity of the one or more electronic promotional items is determined using information read from the one or more merchant tags;

2. The electronic promotion system of claim 1, wherein the plurality of electronic promotional items are promotions selected from the group consisting of electronic coupons, electronic loyalty cards and electronic payment cards.

3. The electronic promotion system of claim 1, wherein the one or more electronic promotional items are expired by deleting or modifying the one or more electronic promotional items on the storage device.

4. The electronic promotion system of claim 1, wherein the one or more electronic promotional items are expired by deleting or modifying validation information associated with the one or more electronic promotional items.

5. The electronic promotion system of claim 1, wherein the one or more electronic promotional items are expired by storing an indicator of the same associated with the one or more electronic promotional items on the storage device.

6. The electronic promotion system of claim 1, wherein the validity of the one or more electronic promotional items is determined using a public encryption key read from the one or more merchant tags.

7. The electronic promotion system of claim 1, wherein the validity of the one or more electronic promotional items is determined based on one or more validation rules.

8. A mobile device for an electronic promotion system comprising:
a communications device configured to retrieve one or more electronic promotional items from a remote distribution server;
validation information associated with the one or more electronic promotional items;
a scanning device for reading one or more merchant tags;
a processor configured to determine the validity of the one or more electronic promotional items based on the validation information and information read from the one or more merchant tags;
a display screen configured to present a validity notification if the one or more electronic promotional items is valid; and
a storage device configured to store the one or more electronic promotional items locally on the mobile device, and to expire the one or more electronic promotional items to prevent subsequent use of the one or more electronic promotional items;
wherein the one or more electronic promotional items are expired locally on the mobile device without communication with the remote distribution server.

9. The mobile device of claim 8, wherein the expiration of the one or more electronic promotional items is initiated by an input button presented on the display screen along with the validity notification.

10. The mobile device of claim 8, wherein the one or more electronic promotional items are expired by deleting or modifying at least a portion of the validation information, the one or more electronic promotional items, or both from the storage device.

11. The mobile device of claim 8, wherein the one or more electronic promotional items are high value coupons offering discounts of at least 20%.

12. The mobile device of claim 8, wherein the communication device is configured to communicate with the distribution server only when retrieving the one or more electronic promotional items.

13. The mobile device of claim 8, wherein the scanning device is an optical device configured to read one or more types of barcodes.

14. The mobile device of claim 8, wherein the mobile device is a portable device selected from the group consisting of a smartphone, tablet, PDA, and portable media player.

15. A method for distributing and expiring a plurality of electronic promotional items comprising:
receiving the plurality of electronic promotional items at a distribution server from one or more merchants;
receiving a selection of one or more of the plurality of electronic promotional items from a customer using a portable customer device;
storing the selection of the one or more electronic promotional items on the portable customer device;
generating one or more merchant tags for distribution and display at one or more business locations of the one or more merchants;
reading the one or more merchant tags with a scanning device of the portable customer device;
determining the validity of the one or more electronic promotional items using the portable customer device and information read from the one or more merchant tags;
presenting a validity notification to the one or more merchants via a display screen of the customer device to allow redemption of the one or more electronic promotional items if the one or more electronic promotional items are determined to be valid; and
expiring the one or more electronic promotional items locally at the portable customer device without communication with the distribution server to prevent subsequent use of the one or more electronic promotional items.

16. The method of claim 15 further comprising receiving payment from the customer and associating an amount of the payment with an electronic promotional item in the selection of the one or more electronic promotional items.

17. The method of claim 15, wherein the portable customer device is a mobile device belonging to the customer.

18. The method of claim 15, wherein the one or more electronic promotional items are high value coupons offering at least a 20% discount.

19. The method of claim 15, wherein the one or more electronic promotional items are expired by deleting validation information necessary to validate the one or more electronic promotional items from the portable customer device.

20. The method of claim 15 further comprising presenting an input button on the display screen configured to initiate the expiration of the one or more electronic promotional items when engaged.
